(19) United States
(12) Patent Application Publication
(10) Pub. No.: US 2015/0089149 A1
(43) Pub. Date: Mar. 26, 2015

(54) ARITHMETIC PROCESSING DEVICE AND CONTROL METHOD FOR ARITHMETIC PROCESSING DEVICE

(71) Applicant: FUJITSU LIMITED, Kawasaki-shi (JP)

(72) Inventor: Shigeru Kimura, Hachiouji (JP)

(21) Appl. No.: 14/447,117

(22) Filed: Jul. 30, 2014

(30) Foreign Application Priority Data
Sep. 20, 2013 (JP) 2013-195562

(51) Int. Cl. G06F 12/08

(52) U.S. Cl. CPC G06F 12/0862; G06F 2212/602
USPC 711/137

(57) ABSTRACT

An arithmetic processing device includes: a cache memory configured to store data in a plurality of cache lines; a hardware prefetch circuit configured to prefetch data to a cache line subsequent to a cache line in which cache misses occur when the cache misses occur in cache lines whose number is p at successive addresses in the cache memory; and a controller configured to change values whose number is p in the hardware prefetch circuit when a number-of-cache-misses specifying instruction is input.

### CROSS-REFERENCE TO RELATED APPLICATION

This application is based upon and claims the benefit of priority of the prior Japanese Patent Application No. 2013-195562 filed on Sep. 20, 2013, the entire contents of which are incorporated herein by reference.

### FIELD

The embodiments discussed herein are related to an arithmetic processing device and a control method for an arithmetic processing device.

### BACKGROUND

There has been known an arithmetic processing device where a prefetch instruction instructing to preliminarily transfer data from a main memory to a cache memory is dynamically inserted into a sequence of instructions and executed. Such a technique has been disclosed in Japanese Laid-open Patent Publication No. 2003-223359. A prefetch target selection mechanism selects an instruction to serve as a target of prefetch processing, from among instructions causing cache misses. An address prediction mechanism predicts a memory access address at the time of execution of the instruction determined to serve as the target of the prefetch processing by the prefetch target selection mechanism. A prefetch instruction insertion position determination mechanism determines a position in the sequence of instructions, at which a prefetch instruction corresponding to the instruction determined to serve as the target of the prefetch processing by the prefetch target selection mechanism is to be inserted. At the insertion position determined by the prefetch instruction insertion position determination mechanism, a prefetch instruction insertion mechanism inserts the prefetch instruction having, as an operand, the memory access address predicted by the address prediction mechanism.

In addition, there has been known a moving image data decoding device utilizing a motion compensation method. Such a technique has been disclosed in Japanese Laid-open Patent Publication No. 2006-41898. A cache memory temporarily stores therein image data. Based on a motion vector obtained by analyzing an encoded bit stream, a reference macroblock position determination mechanism determines a position of a reference macroblock on a reference frame, which corresponds to a decoding target macroblock. In a case where data of the reference macroblock is not stored in a cache memory, a preload address specifying mechanism determines whether the reference macroblock includes a cache line boundary, and in a case of including the cache line boundary, the preload address specifying mechanism specifies a position of the cache line boundary, as a data preload leading address from a memory in which the data of the reference macroblock is stored.

In addition, there has been known a cache memory connected to a processor and a main storage device. Such a technique has been disclosed in Japanese Laid-open Patent Publication No. 2010-146145. A data array holds a copy of data the main storage device saves therein, in units of lines. A memory control mechanism reads data from the main storage device, and writes a copy of data into individual lines of the data array. A control information memory holds management information managing the copy of data held in the individual lines, and usage information indicating a usage status of the copy of data held in the individual lines. In response to a request from the processor, a cache control mechanism determines, based on the management information, whether the copy of data is held in the data array. In addition, in a case where the copy of data is held, the cache control mechanism reads data from the data array, and in a case where the copy of data is not held, the cache control mechanism instructs the memory control mechanism to read data from the main storage device. Based on the usage information, a prefetch control mechanism determines the number of prefetch lines the memory control mechanism is to prefetch. In a case of reading data from the main storage device in response to the instruction from the cache control mechanism, the memory control mechanism performs prefetching in accordance with the number of prefetch lines.

In addition, a dynamic tag matching circuit has been known. Such a technique has been disclosed in Japanese Laid-open Patent Publication No. 10-91520. An address comparison circuit receives a first address signal and a second address signal, and in a case where the first address signal is different from the second address signal, the address comparison circuit generates an address miss signal, as an output of the address comparison circuit. Regardless of whether or not the first address signal is different from the second address signal, when receiving at least one forced miss input signal forcing a miss between the first address signal and the second address signal, a forced miss circuit generates a forced miss signal, as an output of the forced miss circuit. At a time synchronized with a time when the address comparison circuit outputs the address miss signal, the forced miss circuit outputs the forced miss signal so that the forced miss circuit and the address comparison circuit mutually simultaneously generate the respective outputs.

In addition, there has been known an instruction controller including a cache memory storing therein data whose usage frequency is high, from among data stored in a main memory. Such a technique has been disclosed in Japanese Laid-open Patent Publication No. 2011-13864. A first free area determiner determines whether there is a vacancy in an instruction buffer in which instruction fetch data received from the cache memory is saved. In a case where the first free area determiner determines that there is a vacancy in the instruction buffer, a second free area determiner determines whether or not there are at least two or more entries in a move-in buffer within the cache memory, the move-in buffer managing an instruction fetch request queue sent out from the cache memory to the main memory. In a case where the second free area determiner determines that there are at least two or more entries in the move-in buffer within the cache memory, an instruction controller outputs an instruction prefetch request to the cache memory, at an address boundary according to a line size of a cache line.

In the arithmetic processing device, the cache memory faster than the main memory is arranged between the processor and the main memory, and by placing recently referenced data on the cache memory, a wait time due to main memory reference is reduced. However, in calculation utilizing large-scale data, such as numerical calculation processing, locality of reference of data is low. Therefore, there is a problem that a cache miss occurs frequently and it is difficult to sufficiently reduce the wait time due to the main memory reference.

### SUMMARY

According to an aspect of the embodiments, an arithmetic processing device includes: a cache memory configured to store data in a plurality of cache lines; a hardware prefetch circuit configured to prefetch data to a cache line subsequent to a cache line in which cache misses occur when the cache misses occur in cache lines whose number is p at successive addresses in the cache memory; and a controller configured to change values whose number is p in the hardware prefetch circuit when a number-of-cache-misses specifying instruction is input.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an arithmetic processing device according to the present embodiment;

FIG. 2A is a diagram illustrating a source program the arithmetic processing device in FIG. 1 executes and an assembly language corresponding thereto;

FIG. 2B is a diagram illustrating a primary operand cache memory in the arithmetic processing device;

FIG. 3A is a diagram illustrating a source program the arithmetic processing device in FIG. 1 executes and an assembly language corresponding thereto;

FIG. 3B is a diagram illustrating the primary operand cache memory in the arithmetic processing device;

FIG. 4A is a diagram illustrating a source program the arithmetic processing device in FIG. 1 executes and an assembly language corresponding thereto;

FIG. 4B is a diagram illustrating the primary operand cache memory in the arithmetic processing device;

FIG. 5A is a diagram illustrating a source program the arithmetic processing device in FIG. 1 executes and an assembly language corresponding thereto;

FIG. 5B is a diagram illustrating the primary operand cache memory in the arithmetic processing device;

FIG. 6 is a diagram illustrating an example of a configuration of a hardware prefetch circuit in FIG. 1;

FIG. 7 is a flowchart illustrating a control method for an arithmetic processing device;

FIGS. 8A and 8B are diagrams illustrating a read address and a prefetch address;

FIG. 9A is a diagram illustrating a cache miss buffer, a cache miss counter, and a prefetch queue in FIG. 6;

FIG. 9B is a flowchart illustrating registration processing for the prefetch queue;

FIG. 10 is a diagram illustrating an example of processing in a case where the number r of free cache lines is 1;

FIG. 11 is a flowchart illustrating processing in a checker in FIG. 6;

FIG. 12 is a flowchart illustrating a generation method for the source programs in FIG. 2A to FIG. 5A;

FIG. 13 is a functional configuration diagram of a compiler;

FIG. 14 is a flowchart illustrating processing in a profiler in FIG. 13;

FIG. 15 is a flowchart illustrating processing in an instruction inserter in the compiler in FIG. 13;

FIGS. 16A and 16B are diagrams illustrating examples of insertion of an instruction, “hpf_start #p−1,#q”, and an instruction, “hpf_stop”;

FIG. 17 is a flowchart illustrating processing in the instruction inserter in the compiler in FIG. 13;

FIG. 18 is a flowchart illustrating processing in the instruction inserter in the compiler in FIG. 13; and

FIG. 19 is a diagram illustrating an example of a hardware configuration of a computer in FIG. 12.

### DESCRIPTION OF EMBODIMENTS

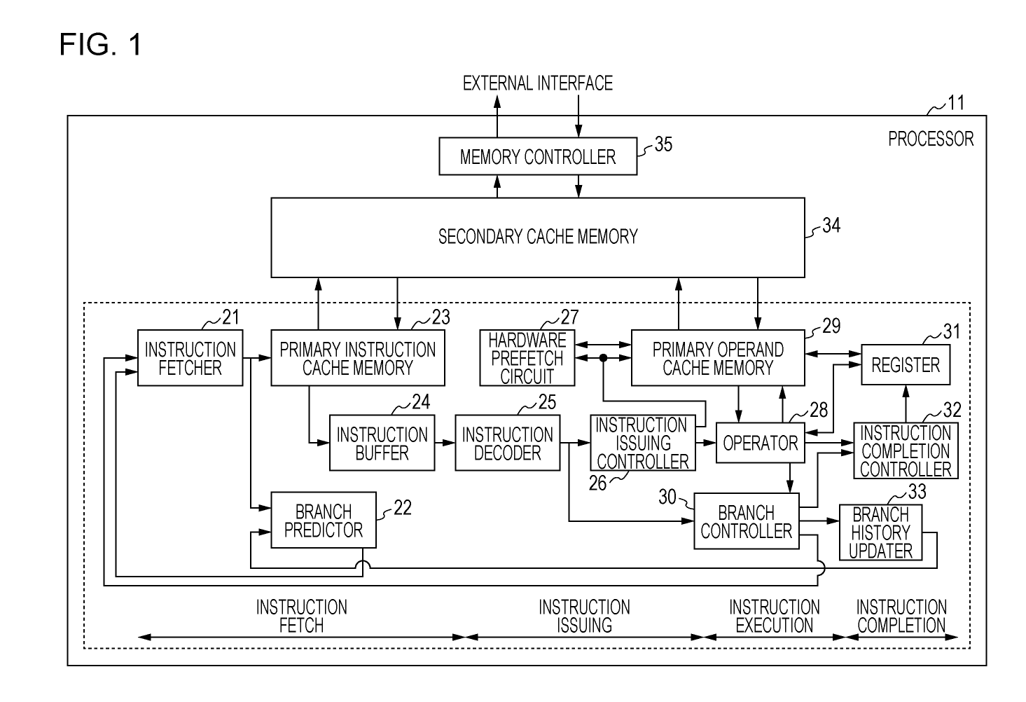

FIG. 1 is a diagram illustrating an example of the configuration of an arithmetic processing device 11 according to the present embodiment. The arithmetic processing device 11 is, for example, a processor, and includes functions for out-of-order execution of an instruction and pipeline processing therefor.

In an instruction fetch stage, an instruction fetcher 21, an instruction buffer 24, a branch predictor 22, a primary instruction cache memory 23, a secondary cache memory 34, and so forth operate. The instruction fetcher 21 receives, from the branch predictor 22, a predicted branch destination address of an instruction to be fetched, and receives, from a branch controller 30, a branch destination address confirmed by branch computation, and so forth. The instruction fetcher 21 selects one address from among the received predicted branch destination address and branch destination address, an address of an instruction scheduled to be executed next to a sequence of instructions to be fetched in a case of not branching, the address of an instruction being created within the instruction fetcher 21, and so forth, and the instruction fetcher 21 confirms a subsequent instruction fetch address. The instruction fetcher 21 outputs the confirmed instruction fetch address to the primary instruction cache memory 23, and fetches an instruction code corresponding to the output instruction fetch address after the confirmation.

The primary instruction cache memory 23 is a memory storing therein a portion of data in the secondary cache memory 34, and the secondary cache memory 34 is a memory storing therein a portion of data in a main memory accessible through a memory controller 35. In a case where no data at a corresponding address exists in the primary instruction cache memory 23, data is fetched from the secondary cache memory 34, and in a case where no corresponding data exists in the secondary cache memory 34, data is fetched from the main memory. In the present embodiment, since the main memory is placed outside of the arithmetic processing device 11, input-output control with the main memory located outside is performed through the memory controller 35. An instruction code fetched from a corresponding address in the primary instruction cache memory 23, the secondary cache memory 34, or the main memory is stored in the instruction buffer 24.

The branch predictor 22 receives the instruction fetch address output from the instruction fetcher 21, and executes branch prediction in parallel with instruction fetch. The branch predictor 22 performs branch prediction, based on the received instruction fetch address, and returns, to the instruction fetcher 21, a branch direction indicating establishment or non-establishment of a branch, and a predicted branch destination address. In a case where a predicted branch direction is established, the instruction fetcher 21 selects the predicted branch destination address as a subsequent instruction fetch address.

In an instruction issuing stage, an instruction decoder 25 and an instruction issuing controller 26 operate. The instruction decoder 25 receives an instruction code from the instruction buffer 24, analyzes the type of instruction, a desired execution resource, and so forth, and outputs an analysis result to the instruction issuing controller 26. The instruction issuing controller 26 has the structure of a reservation station. The instruction issuing controller 26 looks at a dependency relationship of a register or the like referenced in an instruction, and determines whether the execution resource is able to execute the instruction, from the update status of a register having a dependency relationship, the execution status of an instruction utilizing the same execution resource, or the like. In a case of determining that the execution resource is able to execute the instruction, the instruction issuing controller 26 outputs, to execution resources such as the operator 28, a hardware prefetch circuit 27, and a primary operand cache memory 29, pieces of information desired for execution of the instruction, such as a register number and an operand address. In addition, the instruction issuing controller 26 also has a function of a buffer storing therein the instruction until the instruction is put into an executable state.

In an instruction execution stage, execution resources such as the hardware prefetch circuit 27, the operator 28, the primary operand cache memory (primary data cache memory) 29, and the branch controller 30 operate. The operator 28 receives data from a register 31 or the primary operand cache memory 29, executes an operation corresponding to an instruction, such as a four arithmetic operations, a logic operation, a trigonometric function operation, or address calculation, and outputs an operation result to the register 31 or the primary operand cache memory 29. In the same way as the instruction cache memory 23, the primary operand cache memory 29 is able to store therein a portion of data in the secondary cache memory 34. The primary operand cache memory 29 is used for loading data from the main memory to the operator 28 or the register 31, based on a load instruction, storing data from the operator 28 or the register 31 to the main memory, based on a store instruction, and so forth. The secondary cache memory 34 is a memory storing therein a portion of data in the main memory accessible through the memory controller 35. In a case where no data at a corresponding address exists in the primary operand cache memory 29, data is fetched from the secondary cache memory 34, and in a case where no corresponding data exists in the secondary cache memory 34, data is fetched from the main memory. If cache misses whose number is p (p is a natural number) successively occur at successive addresses in the primary operand cache memory 29, the hardware prefetch circuit 27 prefetches data subsequent to the cache misses, from the secondary cache memory 34 or the main memory to the primary operand cache memory 29. In other words, in a case of accessing data at successive addresses on the main memory, the hardware prefetch circuit 27 preliminarily prefetches data to be accessed in the future, from the secondary cache memory 34 or the main memory to the primary operand cache memory 29. This enables an access time of data to be reduced. Each execution resource outputs a completion notice of instruction execution to an instruction completion controller 32. In addition, the hardware prefetch circuit 27 is not limited to an primary cache memory, and includes control for prefetching data to be accessed in the future after a secondary cache or a tertiary cache, from a memory, in the same way.

The branch controller 30 receives the type of branch instruction from the instruction decoder 25, and receives a result of an operation to serve as a branch destination address or a branch condition, from the operator 28. In addition, the branch controller 30 determines establishment of a branch in a case where the operation result satisfies the branch condition, determines non-establishment of a branch in a case where the operation result does not satisfy the branch condition, and confirms a branch direction. In addition, the branch controller 30 determines whether the operation result matches the branch destination address and the branch direction at the time of the branch prediction, and controls an order relationship of the branch instruction. In a case where the operation result and the prediction match each other, the branch controller 30 outputs a completion notice of the branch instruction to the instruction completion controller 32. On the other hand, a case where the operation result and the prediction do not match each other means a branch prediction failure. Therefore, the branch controller 30 outputs the completion notice of the branch instruction to the instruction completion controller 32, and outputs, to the instruction fetcher 21, a request to cancel a subsequent instruction and re-fetch the instruction.

In an instruction completion stage, the instruction completion controller 32, the register 31, and a branch history updater 33 operate. Based on the completion notice of the instruction, received from each execution resource, the instruction completion controller 32 performs instruction completion processing in the order of instruction codes stored commit stack entries, and outputs an update instruction for the register 31. If receiving a register update instruction from the instruction completion controller 32, the register 31 executes update of the register, based on data of the operation result received from the operator 28 or the primary operand cache memory 29. Based on a result of the branch computation, received from the branch controller 30, the branch history updater 33 creates and outputs history update data of branch prediction, to the branch predictor 22.

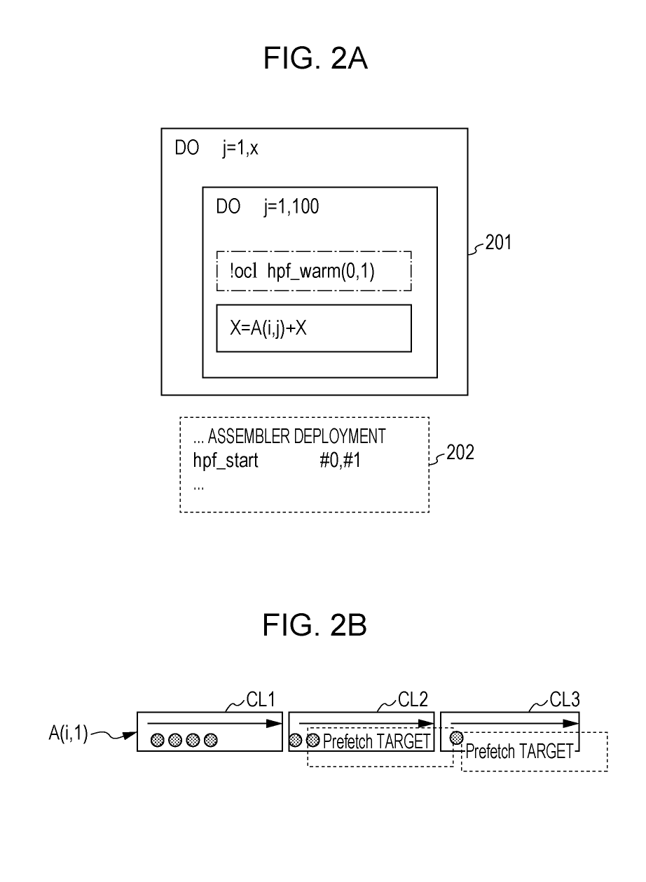

FIG. 2A is a diagram illustrating a source program 201 the arithmetic processing device 11 in FIG. 1 executes and, for example, an assembly language 202 corresponding thereto, and FIG. 2B is a diagram illustrating the primary operand cache memory 29 in the arithmetic processing device 11. The primary operand cache memory 29 includes a plurality of cache lines CL1 to CL3 and so forth. The individual cache lines CL1 to CL3 and so forth are each able to store therein, for example, 16 pieces of data, and stores data of the secondary cache memory 34 or the main memory in units of the cache lines CL1 to CL3 and so forth. The source program 201 indicates an example of a FORTRAN language. First, a case where no instruction of “!ocl hpf_warm(0,1)” exists will be described. Based on loop processing of variables i and j, an instruction of “X=A(i,j)+X” is translated into a machine language by a FORTRAN compiler and executed. Data of arrays A(1,1) to A(100,1) whose number is 100 is stored at successive addresses whose number is 100, within the main memory. In addition, since being not dependent on languages such as C and FORTRAN, the present embodiment will be described hereinafter using FORTRAN as an example. Therefore, the description of FORTRAN in the following, a source description specification based on ocl will be described. However, in a case of another language, for example, a C language, the description may be replaced with #pragma. In addition, the notation of hardware instruction, the format thereof, and the description name and the description format of a source descriptor, ocl, are not limited to the above-mentioned example, and may be arbitrarily changed.

First, the variable j=1 and the variable i=1 are set, and the instruction issuing controller 26 outputs, to the primary operand cache memory 29, a request signal for reading data of the array A(1,1). Since, at first, no data of the array A(1,1) exists in the primary operand cache memory 29, a cache miss occurs. Then, data of the arrays A(1,1) to A(16,1) at 16 successive addresses including the array A(1,1) is read from the secondary cache memory 34 or the main memory, and written into the cache line CL1 within the primary operand cache memory 29. The operator 28 inputs data of the array A(1,1) from the primary operand cache memory 29, and executes an instruction of “X=A(1,1)+X”. In the following, in the same way, the operator 28 inputs data of the arrays A(2,1) to A(16,1) from the primary operand cache memory 29, and executes an instruction of “X=A(i,j)+X”.

Next, the variable j=1 and the variable i=17 are set, and the instruction issuing controller 26 outputs, to the primary operand cache memory 29, a request signal for reading data of the array A(17,1). Since no data of the array A(17,1) exists in the primary operand cache memory 29, a cache miss occurs. Then, data of the arrays A(17,1) to A(32,1) at 16 successive addresses including the array A(17,1) is read from the secondary cache memory 34 or the main memory, and written into the cache line CL2 within the primary operand cache memory 29. The operator 28 inputs data of the array A(17,1) from the primary operand cache memory 29, and executes an instruction of “X=A(17,1)+X”. In the following, in the same way, the operator 28 inputs data of the arrays A(18,1) to A(32,1) from the primary operand cache memory 29, and executes an instruction of “X=A(i,j)+X”.

Here, if cache misses occur in the two cache lines CL1 and CL2 at successive addresses, the hardware prefetch circuit 27 starts prefetch processing for data of the 16 arrays A(33,1) to A(48,1) with respect to the cache line CL3 subsequent to the cache-missed cache lines CL1 and CL2.

Next, the variable j=1 and the variable i=33 are set, and the instruction issuing controller 26 outputs, to the primary operand cache memory 29, a request signal for reading data of the array A(33,1). In this case, a cache miss occurs. However, immediately after that, data of the arrays A(33,1) to A(48,1) in the main memory is written into the cache line CL3 in the primary operand cache memory 29 by the above-mentioned prefetch. Therefore, the operator 28 inputs data of the array A(33,1) from the primary operand cache memory 29, and executes an instruction of “X=A(33,1)+X”. Since, based on the above-mentioned prefetch, the data of the array A(33,1) to A(48,1) is written into the primary operand cache memory 29, it is possible to reduce a data access time. In addition, in the same way as described above, the hardware prefetch circuit 27 prefetches data of the 16 arrays A(49,1) to A(64,1) to a subsequent cache line CL4. The above-mentioned operation is repeated.

As described above, if cache misses occur in the two cache lines CL1 and CL2 at the successive addresses, the hardware prefetch circuit 27 performs prefetching. By making the above-mentioned two values changeable using the number-of-cache-misses specifying instruction, “!ocl hpf_warm(0,1)”, the data access time is further reduced.

If cache misses occur in p cache lines at successive addresses in the primary operand cache memory 29, the hardware prefetch circuit 27 prefetches data to a cache line subsequent to the cache-missed cache lines. Based on an instruction of “!ocl hpf_warm(p−1,1), it is possible to change the value of p. For example, since a first argument is “0” in the instruction of “!ocl hpf_warm(0,1)”, the value of p is set to p=1.

In this case, first, the variable j=1 and the variable i=17 are set, and the instruction issuing controller 26 outputs, to the primary operand cache memory 29, a request signal for reading data of the array A(1,1). Since, at first, no data of the array A(1,1) exists in the primary operand cache memory 29, a cache miss occurs.

Then, if a cache miss occurs in the cache lines CL1 whose number is p (=1) at successive addresses, the hardware prefetch circuit 27 prefetches data of the 16 arrays A(17,1) to A(32,1) to the cache line CL2 subsequent to the cache-missed cache line CL1. After that, in the same way, the hardware prefetch circuit 27 sequentially performs prefetching on the cache line CL3 and subsequent cache lines. In a case where it is clear that the data length of the array A(i,j) to be successively accessed is 17 or more, if a setting of p=1 is adopted using the instruction of “!ocl hpf_warm(p−1,1)”, it is possible to further reduce the data access time.

In addition, as described above, the hardware prefetch circuit 27 prefetches data to the cache line CL2 subsequent to the cache-missed cache line CL1 by one cache line. By making the above-mentioned one value changeable using a prefetch position specifying instruction of software, “!ocl hpf_warm(0,1)”, it is possible to achieve optimization of the data access time.

The hardware prefetch circuit 27 prefetches data to a cache line subsequent to the cache-missed cache line CL1 by q cache lines. Using an instruction of “!ocl hpf_warm(p−1,q)”, it is possible to change the value of q. For example, since a second argument is “0” in the instruction of “!ocl hpf_warm(0,1)”, the value of q is set to q=1.

For example, in a case of p=1 and q=1, the hardware prefetch circuit 27 prefetches data to the cache line CL2 subsequent to the cache-missed cache line CL1 by one cache line, and after that, prefetches data to the cache line CL3 and subsequent cache lines. In a case of p=1 and q=2, the hardware prefetch circuit 27 prefetches data to the cache line CL3 subsequent to the cache-missed cache line CL1 by two cache lines, and after that, prefetches data to the cache line CL4 and subsequent cache lines.

The source program 201 is converted into a machine language corresponding to the assembly language 202 by a compiler of a computer. “!ocl hpf_warm(p−1,q)” in the source program 201 is converted into “hpf_start #p−1,#q” in the assembly language 202. For example, p=1 and q=1 are adopted. When inputting a machine language corresponding to “hpf_start #p−1,#q”, the arithmetic processing device 11 is able to set the values of p and q of the hardware prefetch circuit 27. Specifically, when inputting the machine language corresponding to “hpf_start #p−1,#q”, the instruction issuing controller 26 changes values whose number is p and values whose number is q in the hardware prefetch circuit 27. In addition, in the hardware prefetch circuit 27, the initial value of p is “2”, and the initial value of q is “1”.

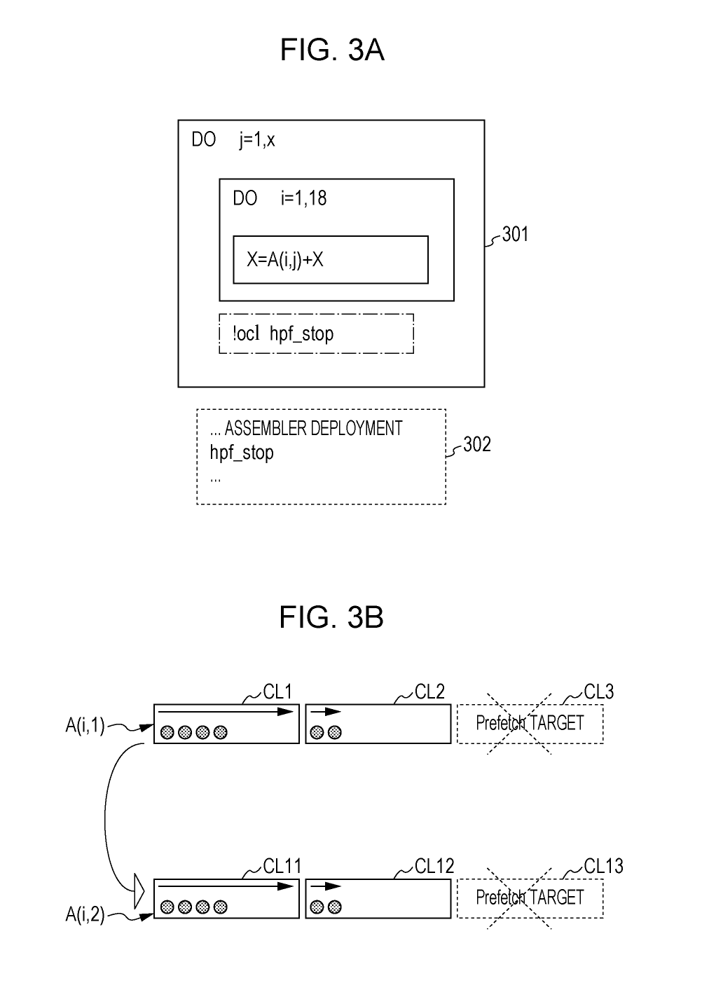

FIG. 3A is a diagram illustrating a source program 301 the arithmetic processing device 11 in FIG. 1 executes and an assembly language 302 corresponding thereto, and FIG. 3B is a diagram illustrating the primary operand cache memory 29 in the arithmetic processing device 11. The primary operand cache memory 29 includes a plurality of cache lines CL1 to CL3, CL11 to CL13, and so forth. The source program 301 indicates an example of a FORTRAN language. First, a case where no instruction of “!ocl hpf_stop” exists will be described. For example, p=2 and q=1 are adopted.

First, the variable j=1 and the variable i=1 are set, and the instruction issuing controller 26 outputs, to the primary operand cache memory 29, a request signal for reading data of the array A(1,1). Since, at first, no data of the array A(1,1) exists in the primary operand cache memory 29, a cache miss occurs. Then, data of the arrays A (1,1) to A (16,1) at 16 successive addresses including the array A(1,1) is read from the secondary cache memory 34 or the main memory, and written into the cache line CL1 within the primary operand cache memory 29. The operator 28 inputs data of the array A(1,1) from the primary operand cache memory 29, and executes an instruction of “X=A(1,1)+X”. In the following, in the same way, the operator 28 inputs data of the arrays A(2,1) to A(16,1) from the primary operand cache memory 29, and executes an instruction of “X=A(i,j)+X”.

Next, the variable j=1 and the variable i=17 are set, and the instruction issuing controller 26 outputs, to the primary operand cache memory 29, a request signal for reading data of the array A(17,1). Since no data of the array A(17,1) exists in the primary operand cache memory 29, a cache miss occurs. Then, data of the arrays A(17,1) to A(32,1) at 16 successive addresses including the array A(17,1) is read from the secondary cache memory 34 or the main memory, and written into the cache line CL2 within the primary operand cache memory 29. The operator 28 inputs data of the array A(17,1) from the primary operand cache memory 29, and executes an instruction of “X=A(17,1)+X”. In the following, in the same way, the operator 28 inputs data of the array A(18,1) from the primary operand cache memory 29, and executes an instruction of “X=A(18,1)+X”.

Here, if cache misses occur in the cache lines CL1 and CL2 whose number is p (=2) at successive addresses, the hardware prefetch circuit 27 prefetches data of 16 arrays A(33,1) to A(48,1) to the cache line CL3 subsequent to the cache-missed cache lines CL1 and CL2. However, since the variable i varies within the range of 1 to 18, access to data of the arrays A(1,1) to A(18,1) is only performed, and prefetch of data of the 16 arrays A(33,1) to A(48,1) in the cache line CL3 is wasted.

After that, the variable j=2 and the variable i=1 are set, and the instruction issuing controller 26 outputs, to the primary operand cache memory 29, a request signal for reading data of the array A(1,2). Since no data of the array A(1,2) exists in the primary operand cache memory 29, a cache miss occurs. Then, data of the arrays A(1,2) to A(16,2) at 16 successive addresses including the array A(1,2) is read from the secondary cache memory 34 or the main memory, and written into the cache line CL11 within the primary operand cache memory 29. The operator 28 inputs data of the array A(1,2) from the primary operand cache memory 29, and executes an instruction of “X=A(1,2)+X”. In the following, in the same way, the operator 28 inputs data of the arrays A(2,2) to A(16,2) from the primary operand cache memory 29, and executes an instruction of “X=A(i,j)+X”.

Next, the variable j=2 and the variable i=17 are set, and the instruction issuing controller 26 outputs, to the primary operand cache memory 29, a request signal for reading data of the array A(17,2). Since no data of the array A(17,2) exists in the primary operand cache memory 29, a cache miss occurs. Then, data of the arrays A(17,2) to A(32,2) at 16 successive addresses including the array A(17,2) is read from the secondary cache memory 34 or the main memory, and written into the cache line CL12 within the primary operand cache memory 29. The operator 28 inputs data of the array A(17,2) from the primary operand cache memory 29, and executes an instruction of “X=A(17,2)+X”. In the following, in the same way, the operator 28 inputs data of the array A(18,2) from the primary operand cache memory 29, and executes an instruction of “X=A(18,2)+X”.

Here, if cache misses occur in the cache lines CL11 and CL12 whose number is p (=2) at successive addresses, the hardware prefetch circuit 27 prefetches data of 16 arrays A(33,2) to A(48,2) to the cache line CL13 subsequent to the cache-missed cache lines CL11 and CL12. However, since the variable i varies within the range of 1 to 18, access to data of the arrays A(1,2) to A(18,2) is only performed, and prefetch of data of the 16 arrays A(33,2) to A(48,2) in the cache line CL13 is wasted.

The prefetch stop instruction, “!ocl hpf_stop”, is able to stop prefetch based on the hardware prefetch circuit 27. By placing the prefetch stop instruction, “!ocl hpf_stop”, after loop processing of the variable i, it is possible to stop the above-mentioned prefetch of the cache lines CL3 and CL13 after the variable i becomes 18. If being instructed to be stopped during the processing of the prefetch of the cache lines CL3 and CL13, a prefetch time is relatively long, and hence, to be able to stop the prefetch in mid-flow has great effect.

The source program 301 is converted into a machine language corresponding to the assembly language 302 by the compiler of the computer. “!ocl hpf_stop” in the source program 301 is converted into “hpf_stop” in the assembly language 302. When inputting a machine language corresponding to “hpf_stop”, the arithmetic processing device 11 stops prefetch based on the hardware prefetch circuit 27. Specifically, when inputting the machine language corresponding to “hpf_stop”, the instruction issuing controller 26 stops prefetch based on the hardware prefetch circuit 27.

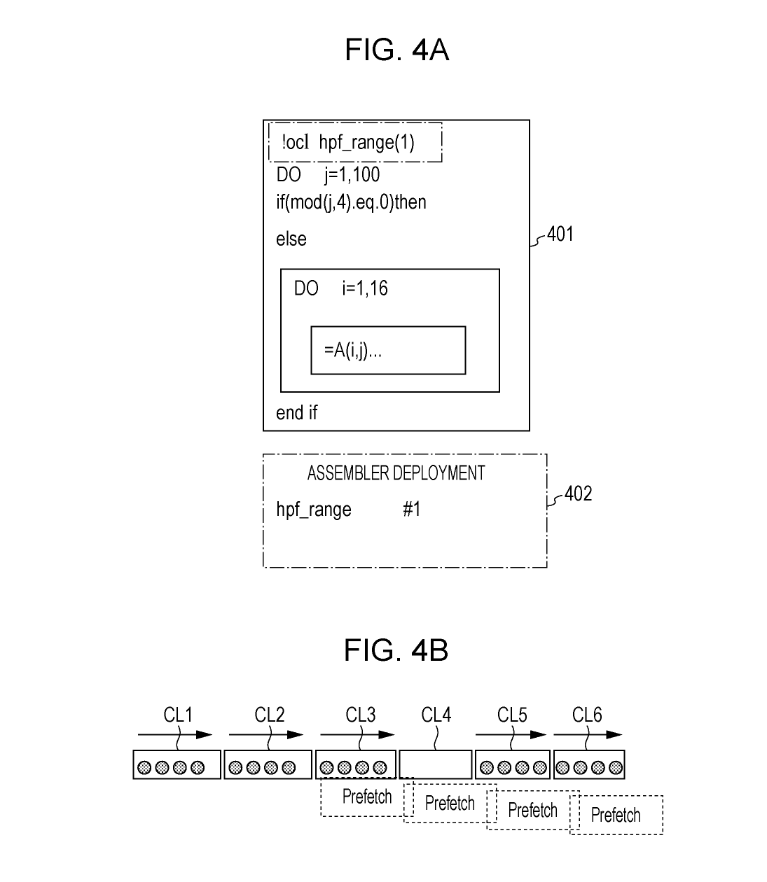

FIG. 4A is a diagram illustrating a source program 401 the arithmetic processing device 11 in FIG. 1 executes and an assembly language 402 corresponding thereto, and FIG. 4B is a diagram illustrating the primary operand cache memory 29 in the arithmetic processing device 11. The primary operand cache memory 29 includes a plurality of cache lines CL1 to CL6 and so forth. The source program 401 indicates an example of a FORTRAN language. First, a case where no instruction of “!ocl hpf_range(1)” exists will be described. For example, p=2 and q=1 are adopted. In addition, it is assumed that the one-dimensional size of an array A is 16. For example, it is assumed that the definition of an array size is A(16,8192). In addition, here, it is assumed that a cache line length is 128 bytes as an example. Then, since the one-dimensional size is equal to the cache line length (128=16*8), the example corresponds to a case where addresses of memory access become continuous even if array access two-dimensionally shifts in such a manner as from A(16,1) to A(1,2).

First, the variable j=1 and the variable i=1 are set, and since a remainder obtained by dividing the variable j (=1) by 4 is “1” and not “0”, the instruction issuing controller 26 outputs, to the primary operand cache memory 29, a request signal for reading data of the array A(1,1). Since no data of the array A(1,1) exists in the primary operand cache memory 29, a cache miss occurs. Then, data of the arrays A(1,1) to A(16,1) at 16 successive addresses including the array A(1,1) is read from the secondary cache memory 34 or the main memory, and written into the cache line CL1 within the primary operand cache memory 29. The operator 28 inputs data of the array A(1,1) from the primary operand cache memory 29, and executes an instruction utilizing the array A(1,1). In the following, in the same way, the operator 28 inputs data of the arrays A(2,1) to A(16,1) from the primary operand cache memory 29, and executes an instruction utilizing the array A(i,j).

Next, the variable j=2 and the variable i=1 are set, and since a remainder obtained by dividing the variable j (=2) by 4 is “2” and not “0”, the instruction issuing controller 26 outputs, to the primary operand cache memory 29, a request signal for reading data of the array A(1,2). Since no data of the array A(1,2) exists in the primary operand cache memory 29, a cache miss occurs. Then, data of the arrays A(1,2) to A(16,2) at 16 successive addresses including the array A(1,2) is read from the secondary cache memory 34 or the main memory, and written into the cache line CL2 within the primary operand cache memory 29. The operator 28 inputs data of the array A(1,2) from the primary operand cache memory 29, and executes an instruction utilizing the array A(1,2). In the following, in the same way, the operator 28 inputs data of the arrays A(2,2) to A(16,2) from the primary operand cache memory 29, and executes an instruction utilizing the array A(i,j).

Memory addresses of the arrays stored in the cache lines CL1 and CL2 are continuous. Therefore, if cache misses occur in the cache lines CL1 and CL2 whose number is p (=2) at successive addresses, the hardware prefetch circuit 27 starts processing for prefetching data of 16 arrays A(1,3) to A(16,1) to the cache line CL3 subsequent to the cache-missed cache lines CL1 and CL2.

Next, the variable j=3 and the variable i=1 are set, and since a remainder obtained by dividing the variable j (=3) by 4 is “3” and not “0”, the instruction issuing controller 26 outputs, to the primary operand cache memory 29, a request signal for reading data of the array A(1,3). In this case, a cache miss occurs. However, immediately after that, data of the array A(1,3) in the main memory is written into the cache line CL3 in the primary operand cache memory 29 by the above-mentioned prefetch. Therefore, the operator 28 inputs data of the array A(1,3) from the primary operand cache memory 29, and executes an instruction utilizing the array A(1,3). Based on the above-mentioned prefetch, it is possible to reduce the data access time. In addition, in the same way as described above, the hardware prefetch circuit 27 prefetches data of the 16 arrays A(1,4) to A(16,4) to the subsequent cache line CL4.

Next, the variable j=4 and the variable i=1 are set, and since a remainder obtained by dividing the variable j (=4) by 4 is “0”, access to the array A(4,i) is not performed.

Next, the variable j=5 and the variable i=1 are set, and since a remainder obtained by dividing the variable j (=5) by 4 is “1” and not “0”, the instruction issuing controller 26 outputs, to the primary operand cache memory 29, a request signal for reading data of the array A(1,5). Since no data of the array A(1,5) exists in the primary operand cache memory 29, a cache miss occurs. Then, data of the arrays A(1,5) to A(16,5) at 16 successive addresses including the array A(1,5) is read from the secondary cache memory 34 or the main memory, and written into the cache line CL5 within the primary operand cache memory 29. The operator 28 inputs data of the array A(1,5) from the primary operand cache memory 29, and executes an instruction utilizing the array A(1,5). In the following, in the same way, the operator 28 inputs data of the arrays A(2,5) to A(16,5) from the primary operand cache memory 29, and executes an instruction utilizing the array A(i,j). Here, in the hardware prefetch circuit 27, the cache-missed cache lines CL3 and CL5 are not cache lines whose number is P (=2) at successive addresses. Therefore, in this case, the hardware prefetch circuit 27 halts, and does not perform prefetch of the cache line CL5.

Next, the variable j=6 and the variable i=1 are set, and since a remainder obtained by dividing the variable j (=6) by 4 is “2” and not “0”, the instruction issuing controller 26 outputs, to the primary operand cache memory 29, a request signal for reading data of the array A(1,6). Since no data of the array A(1,6) exists in the primary operand cache memory 29, a cache miss occurs. Then, data of the arrays A(1,6) to A(16,6) at 16 successive addresses including the array A(1,6) is read from the secondary cache memory 34 or the main memory, and written into the cache line CL6 within the primary operand cache memory 29. The operator 28 inputs data of the array A(1,6) from the primary operand cache memory 29, and executes an instruction utilizing the array A(1,6). In the following, in the same way, the operator 28 inputs data of the arrays A(2,6) to A(16,6) from the primary operand cache memory 29, and executes an instruction utilizing the array A(i,j).

Here, if cache misses occur in the cache lines CL5 and CL6 whose number is p (=2) at successive addresses, the hardware prefetch circuit 27 prefetches data of 16 arrays A(1,7) to A(16,7) to the cache line CL7 subsequent to the cache-missed cache lines CL5 and CL6.

As described above, in a case where data of the cache line CL4 is not accessed, the hardware prefetch circuit 27 halts once and restarts, and hence, the data access time becomes long. Therefore, in a case where only the one cache line CL4 is a cache line not accessed from among the cache lines CL1 to CL6 at successive addresses, the hardware prefetch circuit 27 treats the cache lines CL1 to CL6 as being successively accessed, and successively prefetches the cache lines CL3 to CL6 and so forth without halting. In other words, even if there are free cache lines whose number is r within successive cache lines whose number is p, the hardware prefetch circuit 27 determines that cache misses occur in the successive cache lines whose number is p. In the case of FIG. 4B, r=1 is adopted. Since this avoids the temporary halt and the restart of the hardware prefetch circuit 27, it is possible to reduce the data access time. Based on a number-of-free-cache-lines specifying instruction, “!oclhpf_range(r)”, it is possible to change the value of r. For example, since an argument is “0” in the instruction of “!ocl hpf_range(1)”, the value of r is set to r=1.

The source program 401 is converted into a machine language corresponding to the assembly language 402 by the compiler of the computer. “!ocl hpf_range(r)” in the source program 401 is converted into “hpf_range #r” in the assembly language 402. For example, r=1 is adopted. When inputting a machine language corresponding to “hpf_range #r”, the arithmetic processing device 11 is able to set values whose number is r in the hardware prefetch circuit 27. Specifically, when inputting the machine language corresponding to “hpf_range #r”, the instruction issuing controller 26 changes values whose number is r in the hardware prefetch circuit 27. In addition, in the hardware prefetch circuit 27, the initial value of r is “0”.

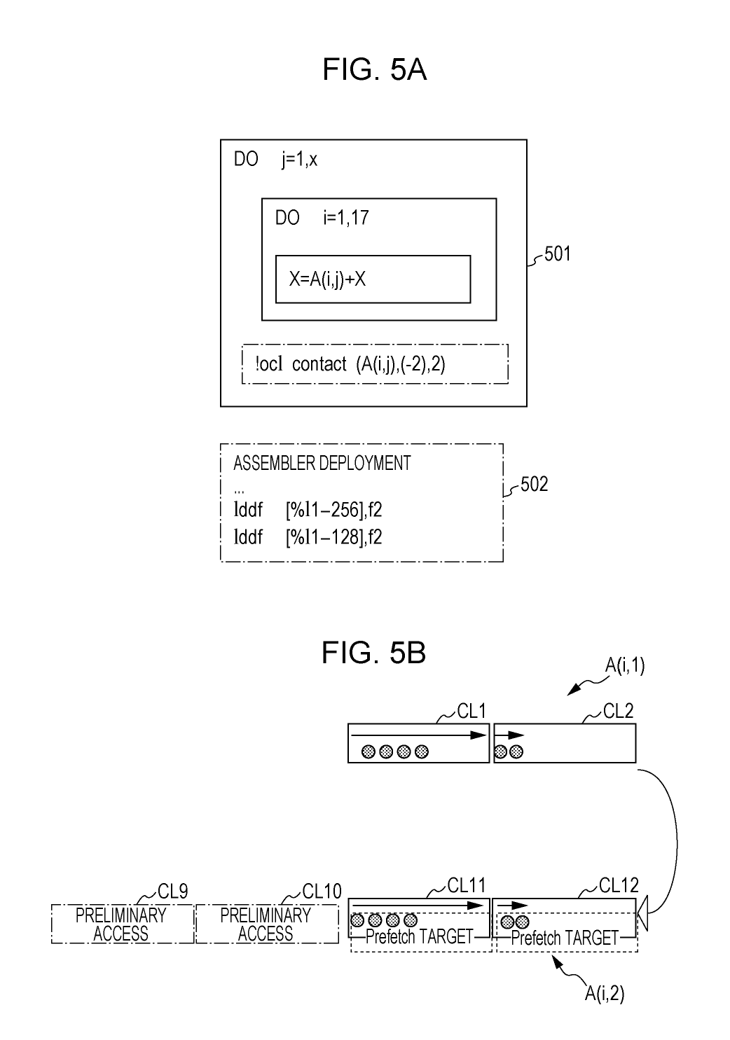

FIG. 5A is a diagram illustrating a source program 501 the arithmetic processing device 11 in FIG. 1 executes and an assembly language 502 corresponding thereto, and FIG. 5B is a diagram illustrating the primary operand cache memory 29 in the arithmetic processing device 11. The primary operand cache memory 29 includes a plurality of cache lines CL1, CL2, CL9 to CL12, and so forth. The source program 501 indicates an example of a FORTRAN language. For example, p=2 and q=1 are adopted.

First, the variable j=1 and the variable i=1 are set, and the instruction issuing controller 26 outputs, to the primary operand cache memory 29, a request signal for reading data of the array A(1,1). Since no data of the array A(1,1) exists in the primary operand cache memory 29, a cache miss occurs. Then, data of the arrays A(1,1) to A(16,1) at 16 successive addresses including the array A(1,1) is read from the secondary cache memory 34 or the main memory, and written into the cache line CL1 within the primary operand cache memory 29. The operator 28 inputs data of the array A(1,1) from the primary operand cache memory 29, and executes an instruction of “X=A(1,1)+X”. In the following, in the same way, the operator 28 inputs data of the arrays A(2,1) to A(16,1) from the primary operand cache memory 29, and executes an instruction of “X=A(i,j)+X”.

Next, the variable j=1 and the variable i=17 are set, and the instruction issuing controller 26 outputs, to the primary operand cache memory 29, a request signal for reading data of the array A(17,1). Since no data of the array A(17,1) exists in the primary operand cache memory 29, a cache miss occurs. Then, data of the arrays A(17,1) to A(32,1) at 16 successive addresses including the array A(17,1) is read from the secondary cache memory 34 or the main memory, and written into the cache line CL2 within the primary operand cache memory 29. The operator 28 inputs data of the array A(17,1) from the primary operand cache memory 29, and executes an instruction of “X=A(17,1)+X”.

Here, if cache misses occur in the cache lines CL1 and CL2 whose number is p (=2) at successive addresses, the hardware prefetch circuit 27 prefetches data of 16 arrays A(33,1) to A(48,1) to the cache line CL3 subsequent to the cache-missed cache lines CL1 and CL2.

After that, the variable j=2 and the variable i=1 are set, and an instruction (for example, a load instruction, “!ocl contact(A(i,j),(−2),2)”) referencing the main memory is executed. The instruction issuing controller 26 reads data at an address preceding the array A(1,2) by two elements, from the main memory, and writes the data into the two cache lines CL9 and CL10. Since, at this time, cache misses occur in the two cache lines CL9 and CL10, the hardware prefetch circuit 27 sequentially prefetches data of the arrays A(1,2) to A(16,2) and data of the arrays A(17,2) to A(32,2) to the cache lines CL11 and CL12. This enables the data access time to be reduced. In the following, in the same way, every time the value of the variable j is changed, a load instruction, “!ocl contact(A(i,j),(−2),2)”, is executed, and data of the arrays A(1,j) to A(16,j) and the arrays A(17,j) to A(32,j) is prefetched to cache lines.

The source program 501 is converted into a machine language corresponding to the assembly language 502 by the compiler of the computer. “!ocl contact(A(i,j),(−2),2)” in the source program 501 is converted into “Iddf [% I1−256],f2” and “Iddf [% I1−128],f2” in the assembly language 502. When inputting a machine language corresponding to the load instruction, “Iddf [% I1−256],f2”, the instruction issuing controller 26 causes data at an address preceding the specified address of the array A(i,j) by two elements to be written into one cache line or a plurality of cache lines, and when inputting a machine language corresponding to the load instruction, “Iddf [% I1−128],f2” the instruction issuing controller 26 causes data at an address preceding the specified address of the array A(i,j) by one element to be written into one cache line or a plurality of cache lines. Using “−2” serving as the second argument of the load instruction, “!ocl contact(A(i,j),(−2),2)”, it is possible to specify the relative position of an element to be subjected to writing. Using “2” serving as the third argument of the load instruction, “!ocl contact(A(i,j),(−2),2)”, it is possible to specify the number of cache lines to be subjected to writing. In the present example, writing is performed on the two cache lines CL9 and CL10. As the load instructions, “Iddf [% I1−256],f2” and “Iddf [% I1−128],f2”, usual load instructions may be used. In addition, here, a method for specifying contact is arbitrary, and, in particular, a method for specifying a parameter and the notation thereof are not limited. For example, a specification format, “!ocl contact(A(i,j),(−n))”, where the number of cache lines subjected to writing is expressly fixed to “1” may be adopted. In that case, “!ocl contact(A(i,j),(−2),2)” indicated above has the same value as specification of, for example, “!ocl contact(A(i,j),(−2))” and “!ocl contact(A(i,j),(−1))”. In addition, if being an instruction for extracting data from a memory, Iddf is not specifically limited.

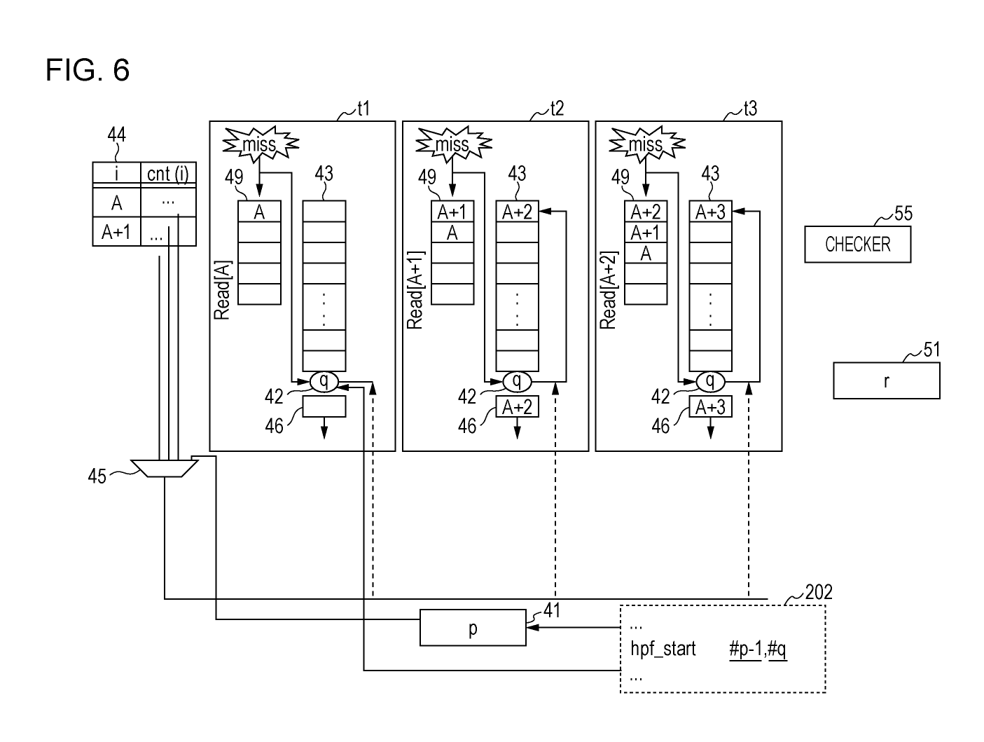

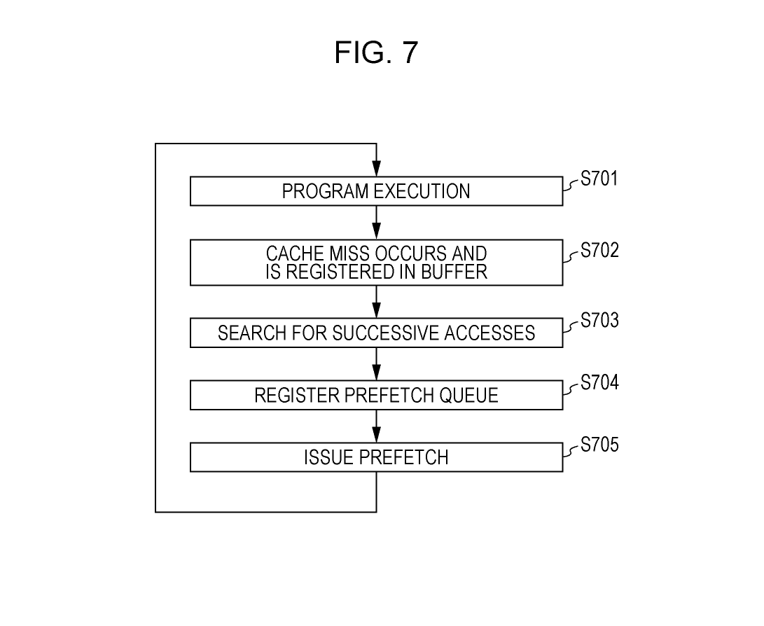

FIG. 6 is a diagram illustrating an example of the configuration of the hardware prefetch circuit 27 in FIG. 1, and FIG. 7 is a flowchart illustrating a control method for the arithmetic processing device 11. Times t1 to t3 each illustrate processing associated with elapse of a time.

In a step S701, the arithmetic processing device 11 inputs and executes an instruction of a machine language corresponding to the assembly language 202. If the instruction, “hpf_start #p−1,#q”, of the assembly language 202 is input, the instruction issuing controller 26 sets the value of the number p of cache misses in a register 41, and sets the value of a prefetch position q in a register 42. The initial value of the number p of cache misses in the register 41 is “2”. The initial value of the prefetch position q in the register 42 is “1”.

Next, in a step S702, in a case where a cache miss occurs in the primary operand cache memory 29, the hardware prefetch circuit 27 registers the number of a cache-missed cache line in a cache miss buffer 49. For example, at the time t1, in a case where a cache line of a cache line number A is cache-missed, the cache-missed cache line number A is registered in the cache miss buffer 49.

With respect to each cache line number i, a cache miss counter 44 stores therein a count value cnt(i). In the cache miss counter 44, the hardware prefetch circuit 27 sets “1” in a count value cnt(A) of the cache-missed cache line number A. The count value cnt(A) in the cache miss counter 44 is cleared to be “0” in a case where the cache line number A is deleted from the cache miss buffer 49.

Next, in a step S703, based on the number p of cache misses in the register 41 and the count value cnt(i) in the cache miss counter 44, a comparison circuit 45 checks whether or not cache misses occur in p cache lines at successive addresses in the cache memory. In a case where p is “2”, since no cache miss occurs in cache lines whose number is p (=2), the comparison circuit 45 does not instruct to prefetch. After that, steps S704 and S705 are bypassed, and in the step S701, a subsequent instruction is executed.

Next, at the time t2, in a case where a cache line of a cache line number A+1 is cache-missed, the hardware prefetch circuit 27 registers the cache-missed cache line number A+1 in the cache miss buffer 49 (step S702). In addition, in the cache miss counter 44, the hardware prefetch circuit 27 sets “1” in a count value cnt(A+1) of the cache-missed cache line number A+1.

Next, based on the number p of cache misses in the register 41 and the count value cnt(i) in the cache miss counter 44, the comparison circuit 45 checks whether or not cache misses occur in p cache lines at successive addresses in the cache memory. In a case where p is “2”, since cache misses occur in the successive cache line numbers A and A+1 whose number is p (=2), the comparison circuit 45 instructs to prefetch.

Next, in the step S704, if being instructed to prefetch by the comparison circuit 45, the hardware prefetch circuit 27 adds the prefetch position q (=1) in the register 42 to the cache-missed cache line number A+1, and registers a cache line number A+2 in a prefetch queue 43.

Next, in the step S705, the hardware prefetch circuit 27 issues prefetch of the cache line number A+2 within the prefetch queue 43, using an issuer 46, and starts prefetch processing. After that, the hardware prefetch circuit 27 deletes the cache line number A+2 within the prefetch queue 43. After that, in the step S701, a subsequent instruction is executed.

Next, at the time t3, in a case where an access request for the cache line number A+2 is issued, a cache line of the cache line number A+2 is cache-missed because the prefetch of the cache line number A+2 is not completed. Therefore, the hardware prefetch circuit 27 registers the cache-missed cache line number A+2 in the cache miss buffer 49 (step S702). In addition, in the cache miss counter 44, the hardware prefetch circuit 27 sets “1” in a count value cnt(A+2) of the cache-missed cache line number A+2.

Next, based on the number p of cache misses in the register 41 and the count value cnt(i) in the cache miss counter 44, the comparison circuit 45 checks whether or not cache misses occur in p cache lines at successive addresses in the cache memory. In a case where p is “2”, since cache misses occur in the successive cache line numbers A+1 and A+2 whose number is p (=2), the comparison circuit 45 instructs to prefetch.

Next, in the step S704, if being instructed to prefetch by the comparison circuit 45, the hardware prefetch circuit 27 adds the prefetch position q (=1) in the register 42 to the cache-missed cache line number A+2, and registers a cache line number A+3 in the prefetch queue 43.

Next, in the step S705, the hardware prefetch circuit 27 issues prefetch of the cache line number A+3 within the prefetch queue 43, using the issuer 46, and starts prefetch processing. After that, the hardware prefetch circuit 27 deletes the cache line number A+3 within the prefetch queue 43.

In addition, while, in the above description, a case where the cache line numbers A, A+1, and A+2 are registered in the cache miss buffer 49 in that ascending order, it is possible to deal with a case of a descending order. In a case where cache line numbers A and A−1 are registered in the cache miss buffer 49, a cache line number A−2 may be registered in the prefetch queue 43 next time.

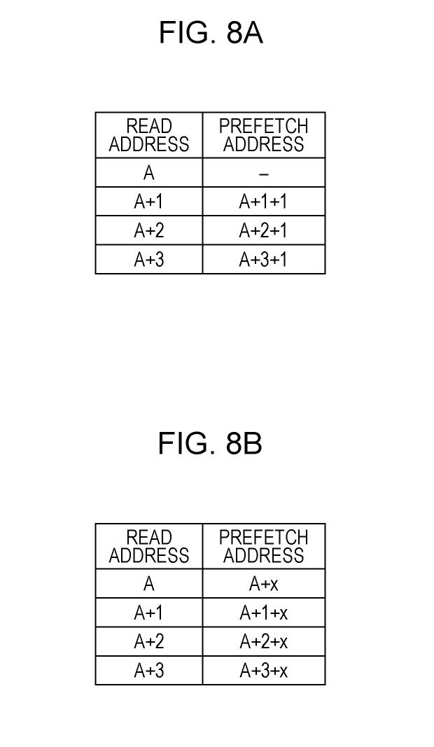

FIG. 8A is a diagram illustrating a read address and a prefetch address in a case where the number p of cache misses is “2” (an initial value) and the prefetch position q is 1 (an initial value). Since a case where a read address is the cache line number A corresponds to one cache miss in the cache line number A, prefetch is not performed. Next, in a case where a read address is the cache line number A+1, cache misses in the cache line numbers A and A+1, whose number is p (=2), successively occurs. Therefore, prefetch of the cache line number A+2 is performed, the cache line number A+2 being obtained by adding the prefetch position q (=1) to the cache-missed cache line number A+1. Next, if a cache miss in the cache line number A+2 occurs, prefetch of the cache line number A+3 is performed in the same way. Next, if a cache miss in the cache line number A+3 occurs, prefetch of a cache line number A+4 is performed in the same way.

FIG. 8B is a diagram illustrating a read address and a prefetch address in a case where the number p of cache misses is “1” and the prefetch position q is x. In a case where a read address is the cache line number A, a cache miss in the cache line number A, whose number is p (=1), occurs. Therefore, prefetch of a cache line number A+x is performed, the cache line number A+x being obtained by adding the prefetch position q (=x) to the cache-missed cache line number A. Next, if a cache miss in the cache line number A+1 occurs, prefetch of a cache line number A+1+x is performed in the same way. Next, if a cache miss in the cache line number A+2 occurs, prefetch of a cache line number A+2+x is performed in the same way. Next, if a cache miss in the cache line number A+3 occurs, prefetch of a cache line number A+3+x is performed in the same way.

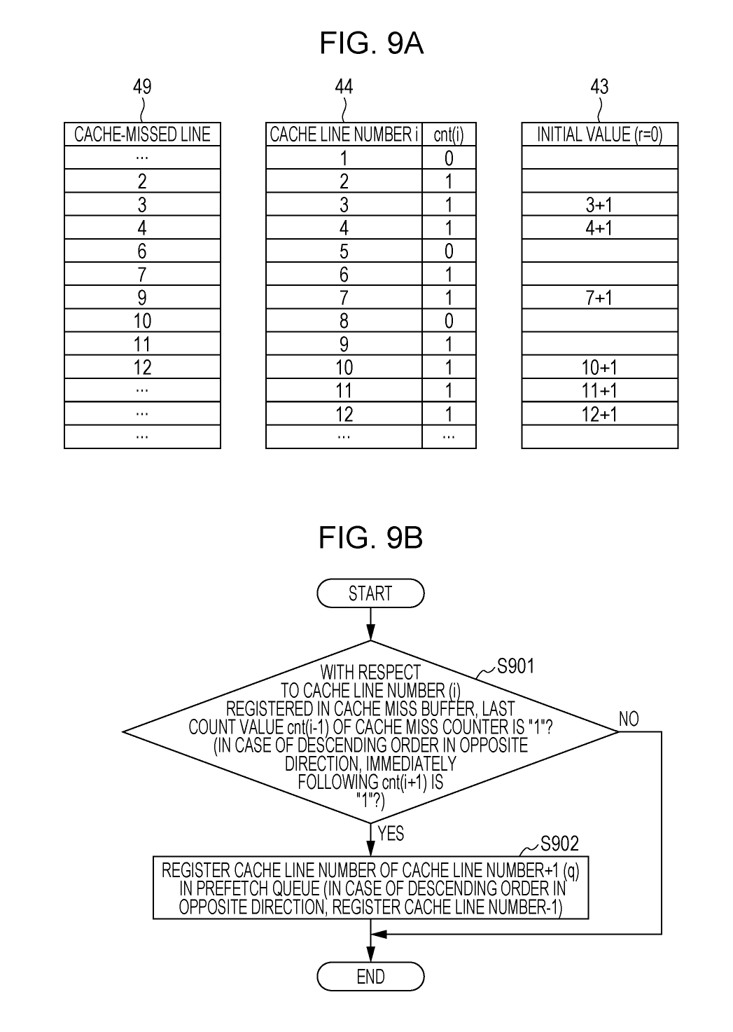

FIG. 9A is a diagram illustrating the cache miss buffer 49, the cache miss counter 44, and the prefetch queue 43 in FIG. 6. In the cache miss buffer 49, a cache-missed cache line number is registered. The cache miss counter 44 has all pairs of a cache line number i and a count value cnt(i), the initial value of the count value cnt(i) is “0”, and the count value cnt(i) of the cache line number i registered in the cache miss buffer 49 is “1”. The initial value of the number r of free cache lines is “0”. In that case, both the count values cnt(2) and cnt(3) of cache line numbers 2 and 3 in the cache miss counter 44 are “1”. Therefore, in a case where it is determined that cache misses occur in successive cache lines whose number is p (=2), and q=1 is satisfied, a cache line number 4 (=3+1) is registered in the prefetch queue 43. In the same way, both the count values cnt(3) and cnt(4) in the cache miss counter 44 are “1”. Therefore, it is determined that cache misses occur in successive cache lines whose number is p (=2), and a cache line number 5 (=4+1) is registered in the prefetch queue 43.

FIG. 9B is a flowchart illustrating registration processing for the prefetch queue 43. First, an example of accessing in ascending order will be described. In a step S901, with respect to the cache line number i registered in the cache miss buffer 49, the hardware prefetch circuit 27 checks whether or not the last count value cnt(i−1) of the cache miss counter 44 is “1”. In a case of “1”, the processing proceeds to a step S902. In the step S902, in the prefetch queue 43, the hardware prefetch circuit 27 registers a cache line number i+1 obtained by adding the prefetch position q (=1) to the cache line number i.

Next, an example of accessing in descending order will be described. In the step S901, with respect to the cache line number i registered in the cache miss buffer 49, the hardware prefetch circuit 27 checks whether or not the immediately following count value cnt(i+1) of the cache miss counter 44 is “1”. In a case of “1”, the processing proceeds to the step S902. In the step S902, in the prefetch queue 43, the hardware prefetch circuit 27 registers a cache line number i−1 obtained by subtracting the prefetch position q (=1) from the cache line number i.

In addition, the number of the prefetch queue 43 is not limited to one, and a plurality of prefetch queues 43 may be prepared. In that case, prefetch processing based on the hardware prefetch circuit 27 is simultaneously executed with respect to a plurality of data streams.

In addition, if the prefetch stop instruction, “hpf_stop”, in FIG. 3A is executed, the hardware prefetch circuit 27 promptly halts the issuer 46, and deletes a cache line number in the prefetch queue 43. This enables the hardware prefetch to be stopped.

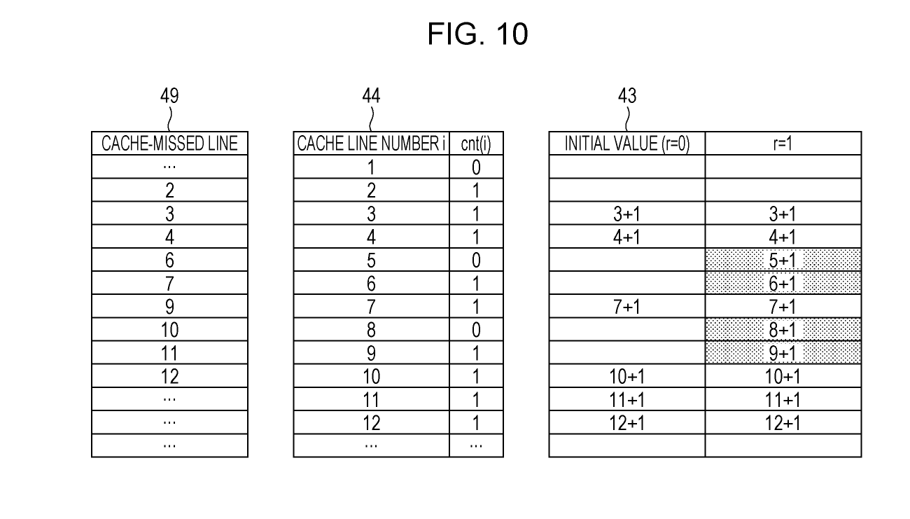

FIG. 10 corresponds to FIG. 9A, and is a diagram illustrating an example of processing in a case where the number r of free cache lines is “1”. If the number-of-free-cache-lines specifying instruction, “hpf_range #r”, in FIG. 4A is executed, the hardware prefetch circuit 27 stores the number r of free cache lines in a register 51 in FIG. 6. Even if there are free cache lines whose number is r (=1) within successive cache lines whose number is p (=2), a checker 55 in FIG. 6 determines that cache misses occur in the successive cache lines whose number is p, and performs registration to the prefetch queue 43. For example, in a case where the cache line number 5 is not accessed, even if there is the free cache line number 5 whose number is r (=1) within the successive cache lines 4 and 5 whose number is p (=2), a cache line number 6 (=5+1) is registered in the prefetch queue 43, the cache line number 6 (=5+1) being obtained by adding the prefetch position q (=1) to the cache line number 5. In addition, in a case where a cache miss in the cache line number 6 occurs, even if there is the free cache line number 5 whose number is r (=1) within the successive cache lines 5 and 6 whose number is p (=2), a cache line number 7 (=6+1) is registered in the prefetch queue 43, the cache line number 7 (=6+1) being obtained by adding the prefetch position q (=1) to the cache line number 6.

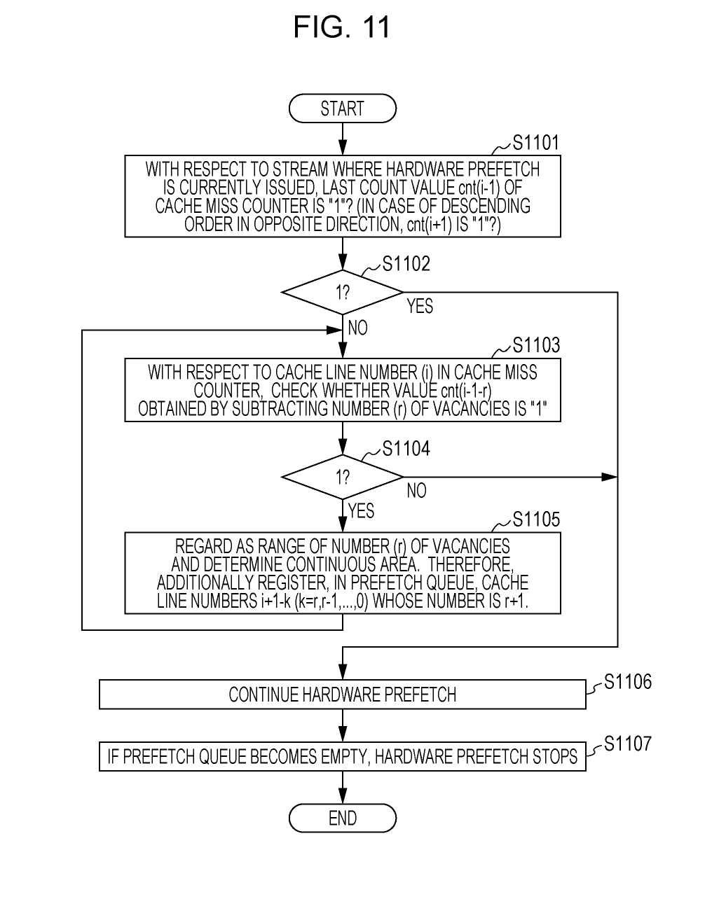

FIG. 11 is a flowchart illustrating processing in the checker 55 in FIG. 6. In a step S1101, in a case of ascending access, the checker 55 checks whether or not the last count value cnt(i−1) of the cache miss counter 44 is “1”, with respect to a data stream of the cache line number i where hardware prefetch is currently issued. In a case of descending access, the checker 55 checks whether or not the immediately following count value cnt(i+1) of the cache miss counter 44 is “1”. In a case of “1” in the step S1102, the processing proceeds to a step S1106, and in a case of “0” in the step S1102, the processing proceeds to a step S1103.

In the step S1103, with respect to the cache line number i in the cache miss counter 44, the checker 55 checks whether or not the count value cnt(i−1−r) of a number i−1−r obtained by subtracting the number r of vacancies in the register 51 from the last cache line number i−1 is “1”. In a case of “1” in a step S1104, the processing proceeds to a step S1105, and in a case of “0” in the step S1104, the processing proceeds to the step S1106.

In the step S1105, the checker 55 determines that there is a free cache line whose number is r (=1) within successive cache lines whose number is p (=2), and additionally registers, in the prefetch queue 43, cache line numbers i+1−k (k=r,r−1, . . . , 0) whose number is r+1. After that, the processing returns to the processing operation in the step S1103.

In the step S1106, the hardware prefetch circuit 27 continues the hardware prefetch. In a step S1107, if the prefetch queue 43 becomes empty, the hardware prefetch circuit 27 stops the hardware prefetch.

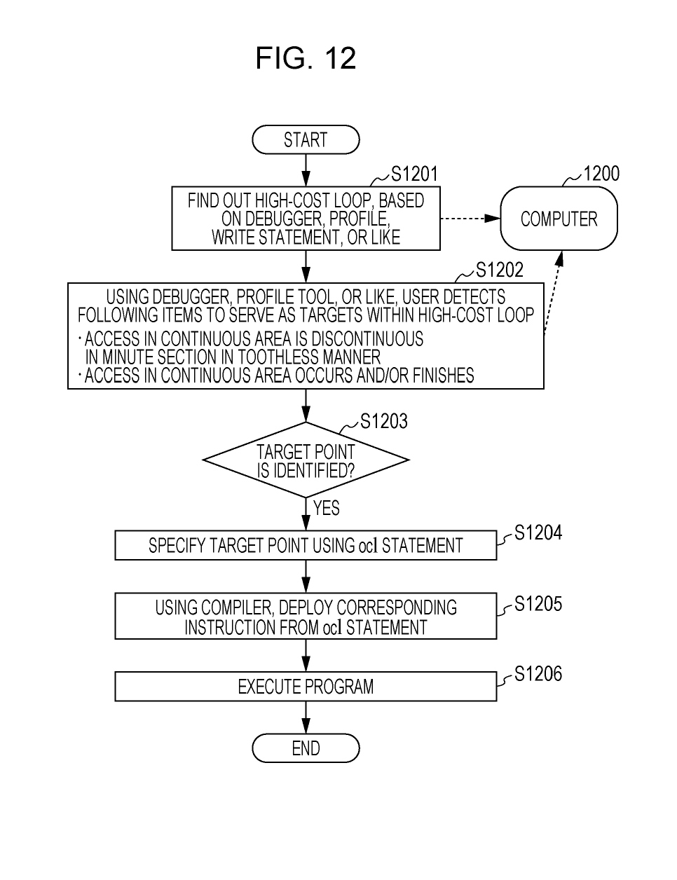

FIG. 12 is a flowchart illustrating a generation method for the source programs 201, 301, 401, and 501 in FIG. 2A to FIG. 5A. In a step S1201, using a computer 1200, a user finds out a point of high-cost loop processing taking a lot of time, based on a debugger, a profile, a write statement, or the like. Next, in a step S1202, using the computer 1200, the user detects a target point of the following (1) or (2) within the high-cost loop processing, by use of the debugger, a profile tool, or the like.

(1) data access in a continuous area is discontinuous in a minute section in a toothless manner.

(2) data access in a continuous area occurs and/or finishes.

Next, in a step S1203, in a case where the user identifies the target point, the processing proceeds to a step S1204. In the step S1204, the user describes an ocl statement in the target point within the source program 201, 301, 401, or 501. Next, in a step S1205, using the computer 1200, the user converts the source program 201, 301, 401, or 501 into a machine language, based on the compiler. The machine language is stored in the main memory. Next, in a step S1206, the arithmetic processing device 11 inputs and executes the machine language within the main memory.

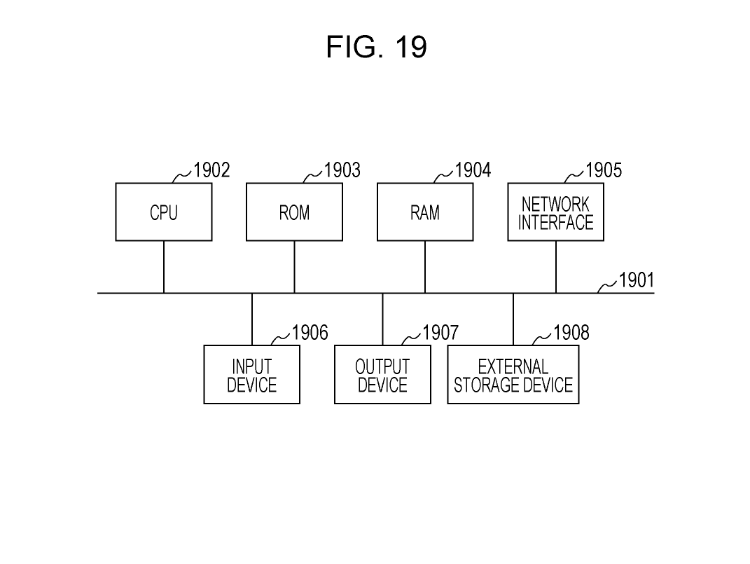

FIG. 19 is a diagram illustrating an example of the hardware configuration of the computer 1200 in FIG. 12. A central processing unit (CPU) 1902, a ROM 1903, a RAM 1904, a network interface 1905, an input device 1906, an output device 1907, and an external storage device 1908 are connected to a bus 1901. The CPU 1902 performs processing or an operation on data, and controls various kinds of configuration elements connected through the bus 1901. The control procedure (computer program) of the CPU 1902 is preliminarily stored in the ROM 1903, and the computer program is executed by the CPU 1902, and thus activated. A computer program is stored in the external storage device 1908, and that computer program is copied into the RAM 1904 and executed. The RAM 1904 is used as a working memory for input-output and transmission-reception of data, and a temporary storage for control of individual configuration elements. The external storage device 1908 is, for example, a hard disk storage device, a CD-ROM, or the like, and even if the power thereof is turned off, a storage content is not lost. The CPU 1902 performs processing by executing the computer program within the RAM 1904. The network interface 1905 is an interface for connecting to a network such as Internet. The input device 1906 is, for example, a keyboard, a mouse, or the like, and able to perform various kinds of specifications, inputs, and so forth. The output device 1907 is a display, a printer, or the like.

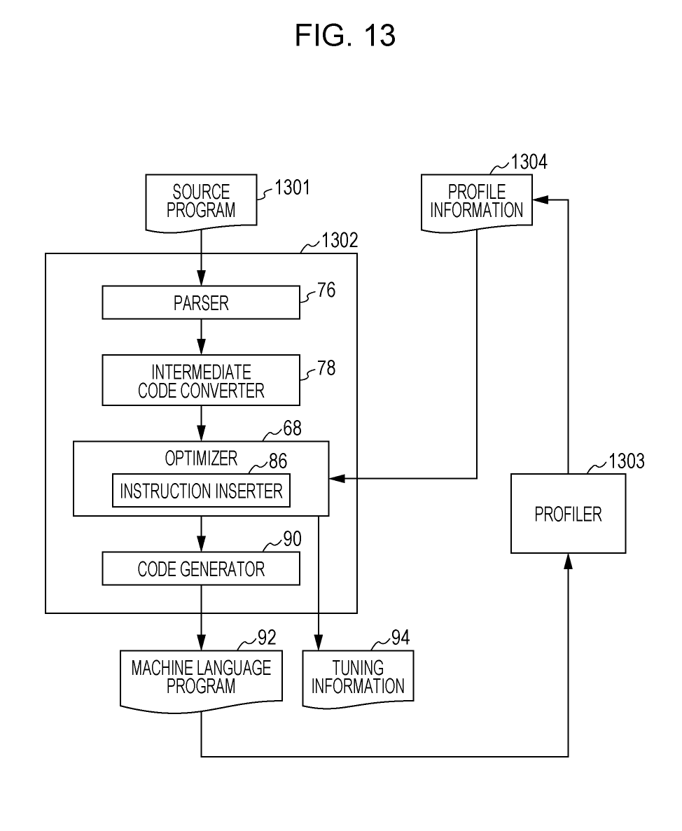

FIG. 13 is the functional configuration diagram of a compiler 1302. The compiler 1302 performs processing by causing the computer in FIG. 19 to execute a program for a compiler. The compiler 1302 includes a parser 76, an intermediate code converter 78, an optimizer 68, and a code generator 90, inputs a source program 1301, and outputs a machine language program 92 and tuning information 94. The optimizer 68 includes an instruction inserter 86.

The source program 1301 corresponds to the source programs 201, 301, 401, and 501 in FIG. 2A to FIG. 5A, and is described using a high-level language such as, for example, a FORTRAN language or a C language. With respect to the source program 1301, the parser 76 extracts reserved words (keywords) or the like, and performs lexical analysis. Based on a given rule, the intermediate code converter 78 converts, into intermediate codes, individual statements of the source program 1301, input from the parser 76. Here, the intermediate code is a code expressed in the form of a function call (for example, a code indicating “+(int a, int b)”: “add an integer number b to an integer number a”). In this regard, however, the intermediate code includes not only such a code of a function-call form but also a machine language instruction of the arithmetic processing device 11. The intermediate code converter 78 references profile information 1304 at the time of generating an intermediate code, and generates an optimum intermediate code.

With respect to the intermediate code output from the intermediate code converter 78, the optimizer 68 performs processing operations such as instruction combination, redundancy removal, instruction rearrangement, and register allocation, and hence, performs improvement of an execution speed, the reduction of a code size, and so forth. The instruction inserter 86 references the profile information 1304, and inserts ocl statements in FIG. 2A to FIG. 5A. In addition, the optimizer 68 outputs the tuning information 94 serving as a hint when the user re-creates the source program 1301. An example of the tuning information 94 is information relating to a cache miss in the cache memory 29. With respect to the intermediate code output from the optimizer 68, the code generator 90 references a conversion table or the like held therewithin, and hence, replaces all codes with machine language instructions. Accordingly, the code generator 90 generates the machine language program 92.

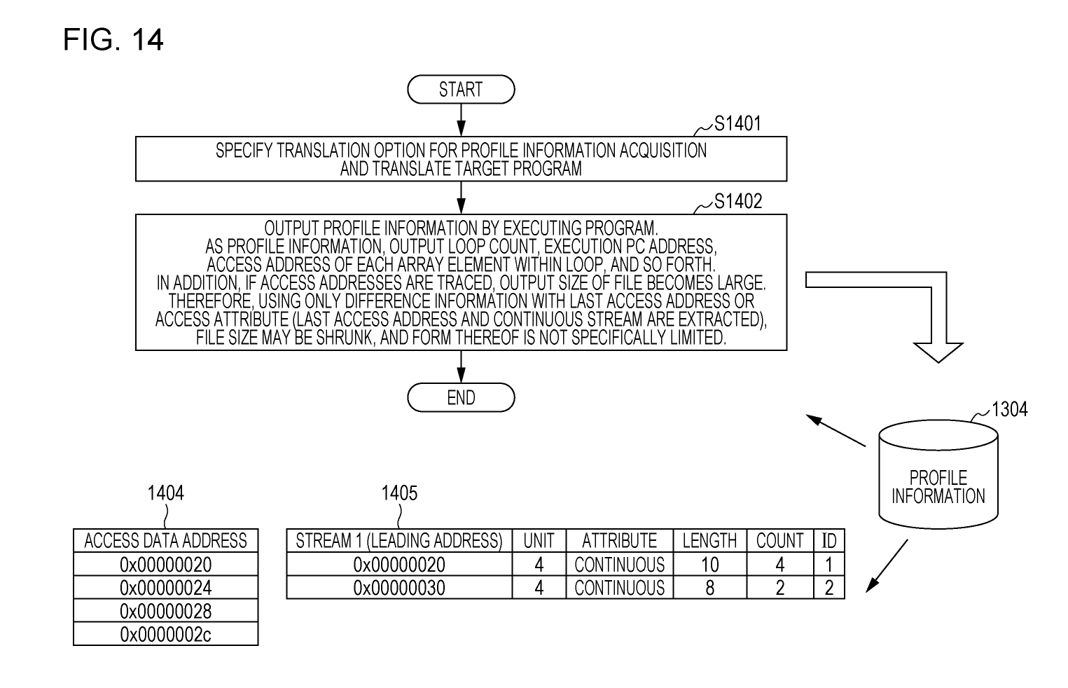

The computer in FIG. 19 executes a program for a profiler, and hence a profiler 1303 performs processing. The profiler 1303 executes the machine language program 92, and generates the profile information 1304. The detail of the profile information 1304 will be described later with reference to FIG. 14. First, the compiler 1302 converts the source program 1301 into the machine language program 92. Next, the profiler 1303 executes the machine language program 92, and hence, generates the profile information 1304. Next, the compiler 1302 references the profile information 1304, inserts an ocl statement, and generates the machine language program 92. Next, the arithmetic processing device 11 executes the machine language program 92.

FIG. 14 is a flowchart illustrating processing in the profiler 1303 in FIG. 13. In a step S1401, the user specifies a translation option for profile information acquisition with respect to the profiler 1303, and causes the machine language program 92 to be translated. In a step S1402, the profiler 1303 outputs the profile information 1304 by executing the machine language program 92. The profile information 1304 includes a loop count, an execution program counter (PC) address, an access address of each array element within a loop, and so forth. In addition, if access addresses are traced, the output size of a file of the profile information 1304 becomes large. Therefore, using only difference information with the last access address or an access attribute (the last access address and a continuous stream are extracted), the file size of the profile information 1304 may be shrunk, and the form thereof is not specifically limited.

The content of the profile information 1304 is, for example, profile information 1404 or 1405. The profile information 1404 includes an access data address, and in a case where four-byte data is stored at each address, data is stored at an address every four addresses. Accordingly, the profile information 1404 indicates that four pieces of data at successive addresses from a “20” address to a “2c” address are accessed in order.

The profile information 1405 includes a leading address of a data stream, a unit for accessing, an attribute, the length of a continuous region, an access count, and a successively accessed stream ID. In addition, in the profile information 1304, the number of cache misses may be aggregated with respect to each access address, and an event of another performance counter and static syntax information at the time of translation may be combined.

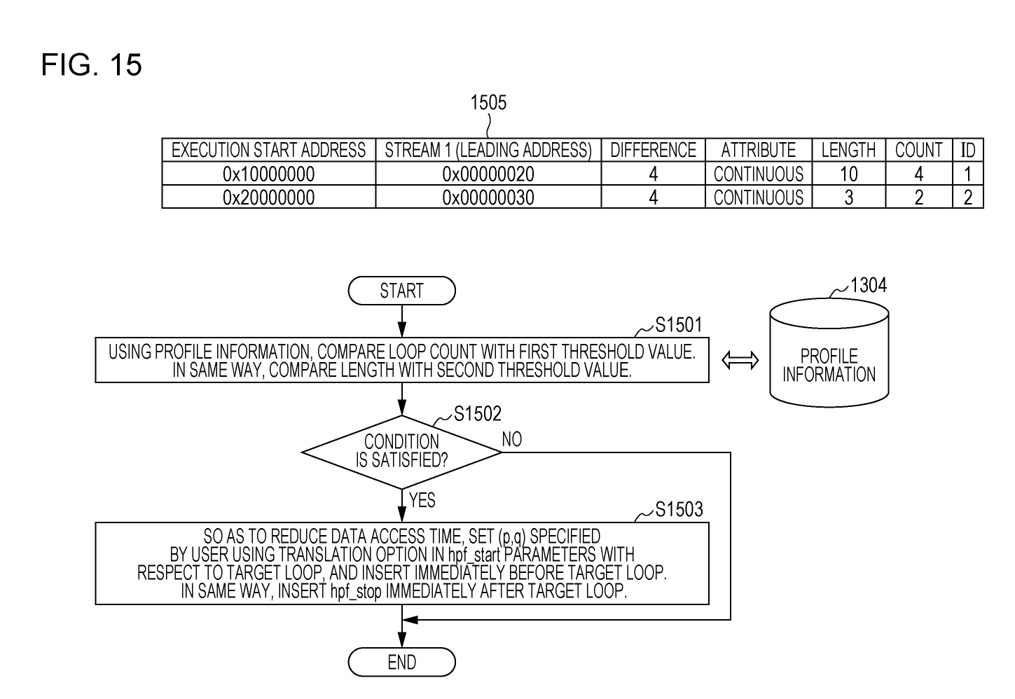

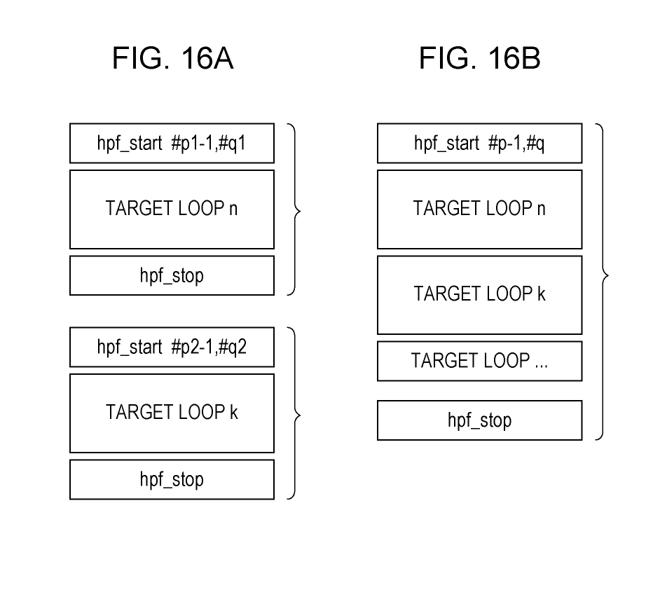

FIG. 15 is a flowchart illustrating processing in the instruction inserter 86 in the compiler 1302 in FIG. 13, and illustrates insertion processing for the instruction, “hpf_start #p−1,#q”, in FIG. 2A and the instruction, “hpf_stop”, in FIG. 3A. The profile information 1304 is, for example, profile information 1505. In a step S1501, the instruction inserter 86 references the profile information 1304, and checks whether or not there is satisfied a condition that a loop count of loop processing within the source program is larger than a first threshold value and the length of data successively accessed based on the loop processing is shorter than a second threshold value. In a step S1502, in a case of satisfying the condition, the processing proceeds to a step S1503, and in a case of not satisfying the condition, the processing is terminated. In the step S1503, as illustrated in FIGS. 16A and 16B, so as to reduce the data access time, the instruction inserter 86 sets, in the instruction, “hpf_start #p−1,#q”, the number p of cache misses and the prefetch position q, specified by the user using an translation option, with respect to target loop processing, and inserts the instruction, “hpf_start #p−1,#q”, immediately before a target loop. In the same way, the instruction inserter 86 inserts the instruction, “hpf_stop”, immediately after the target loop.

In addition, the above-mentioned first and second threshold values may be held within the compiler, and may be given to the compiler by the user from the outside, using a translation option or the like. In addition, the target loop may target all of loops selected by the compiler, and may be limited to only top target loops specified by a number the user specifies using a translation option or the like. In addition, as data subjected to the determination in the step S1502, in addition to the above-mentioned first and second threshold values, the execution time of a loop, the number of cache misses, an event of another performance counter, and static syntax information at the time of translation may be further added and combined, and a determination method is not limited to the above-mentioned method. In addition, in the same way, these threshold values may be held within the compiler, and may be given to the compiler by the user from the outside, using a translation option or the like.

FIG. 16A is a diagram illustrating an example where the number p of cache misses and the prefetch position q, which are different, are specified for each of a target loop n and a target loop k. An instruction, “hpf_start #p1−1,#q1”, is inserted before the target loop n, and the instruction, “hpf_stop”, is inserted after the target loop n. In addition, an instruction, “hpf_start #p2−1,#q2”, is inserted before the target loop k, and the instruction, “hpf_stop”, is inserted after the target loop n.

FIG. 16B is a diagram illustrating an example where the number p of cache misses and the prefetch position q, which are equal, are specified for the target loop n, the target loop k, and so forth. An instruction, “hpf_start #p−1,#q”, is inserted before the target loop n, the target loop k, and so forth and the instruction, “hpf_stop”, is inserted after the target loop n, the target loop k, and so forth.

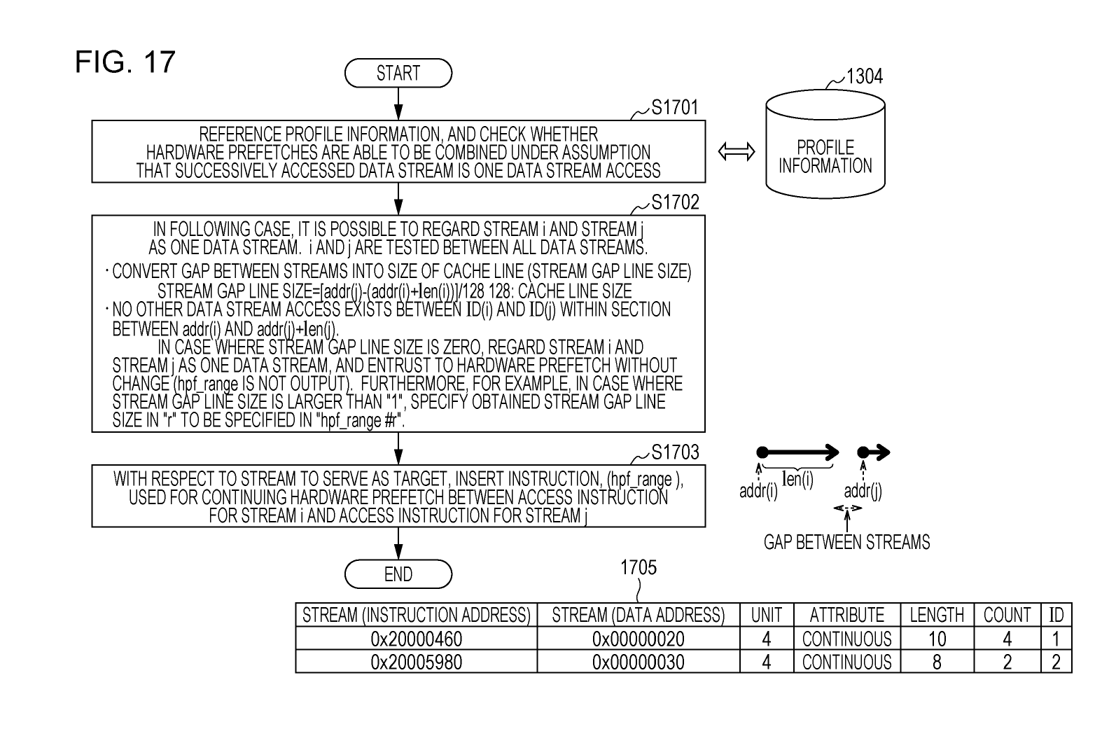

FIG. 17 is a flowchart illustrating processing in the instruction inserter 86 in the compiler 1302 in FIG. 13, and illustrates insertion processing for the instruction, “hpf_range #r”, in FIG. 4A. In a step S1701, the instruction inserter 86 references the profile information 1304, and checks whether hardware prefetches are able to be combined under the assumption that a successively accessed data stream is one data stream access. The profile information 1304 is, for example, profile information 1705.

Next, in a step S1702, in accordance with the following expression, the instruction inserter 86 converts the size of a gap between a data stream i and a data stream j into the size SZ of a cache line. In the example here, it is assumed that the size of the cache line is 128. addr(j) is a leading address of the data stream j, addr(i) is a leading address of the data stream i, len(i) is the length of the data stream i, and len(j) is the length of the data stream j.

SZ=[addr(j)−(addr(i)+Ien(i))]/128

In a case where no other data stream access exists between an access ID(i) and an access ID(j) within a section between the address, addr(i), and an address, addr(j)+Ien(j), the instruction inserter 86 performs the following processing. In that case, in a case where the stream gap line size SZ is zero, the instruction inserter 86 regards the data stream i and the data stream j as one data stream, and entrusts to the hardware prefetch circuit 27 without change. Therefore, the instruction inserter 86 does not insert the instruction, “hpf_range #r”. In addition, in a case where the stream gap line size SZ is larger than “1”, the instruction inserter 86 specifies the obtained stream gap line size SZ, in the number r of free cache lines to be specified in the instruction, “hpf_range #r”. In this case, it is possible to regard the data stream i and the data stream j as one data stream. i and j are tested between all data streams.

For example, in a case of the profile information 1705, there is a vacant space of 6 bytes in a data stream (a stream from 0x20 to 0x20+10) of ID1 and a stream (a stream from 0x30 to 0x38) of ID2. Furthermore, between accesses from ID1 to ID2, no access overlaps with an address range (0x20 to 0x38). Accordingly, it is possible to regard the two stream accesses of ID1 and ID2 as one stream. In a case where a gap between streams is converted into a cache line size and larger than “1”, a value converted into the stream gap line size SZ is specified in the number r of free cache lines to be specified in the instruction, “hpf_range #r”. In this way, it is possible to arbitrarily adjust the number r of free cache lines in the instruction, “hpf_range #r”.

Next, in a step S1703, with respect to a stream to serve as a target, the instruction inserter 86 inserts the instruction, “hpf_range #r”, used for continuing hardware prefetch between an access instruction for the stream i and an access instruction for the stream j.

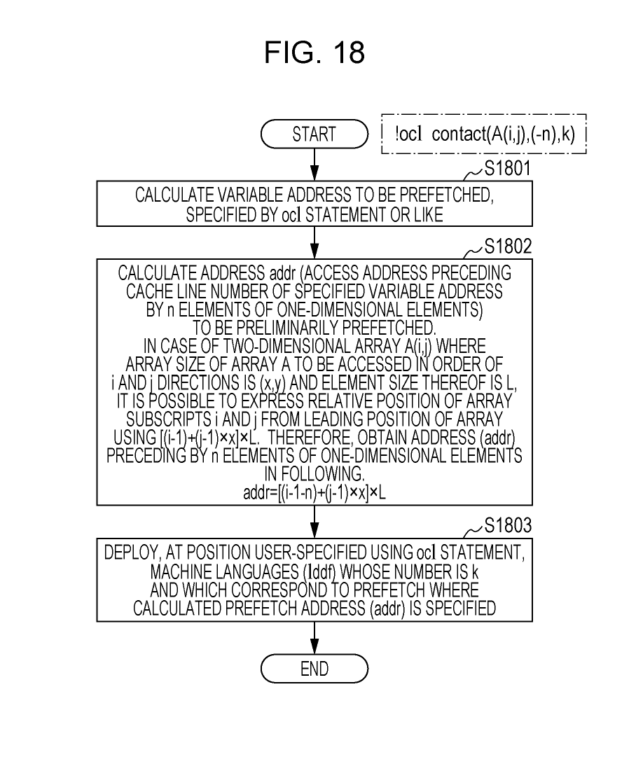

FIG. 18 is a flowchart illustrating processing in the instruction inserter 86 in the compiler 1302 in FIG. 13, and illustrates deployment processing for the instruction, “!ocl contact(A(i,j),(−n),k)”, in FIG. 5A. In a step S1801, the instruction inserter 86 calculates a variable address to be prefetched, specified by “!ocl contact(A(i,j),(−n),k)” or the like.

Next, in a step S1802, in accordance with the following expression, the instruction inserter 86 calculates an address addr (an access address preceding the cache line number of the specified variable address by n elements of one-dimensional elements) to be preliminarily prefetched.

addr=[(i−1−n)+(j−1)×x]×L

Here, in a case of a two-dimensional array A(i,j) where the array size of an array A to be accessed in order of i and j directions is (x,y) and the element size thereof is L, it is possible to express the relative position of array subscripts i and j from the leading position of the array using [(i−1)+(j−1)×x]×L. In addition, in the same way as the two-dimensional array, the same may apply to one-dimensional, three-dimensional, and higher-dimensional arrays.

Next, in a step S1803, since the second argument is “−n” and the number of cache lines subjected to writing is “k”, the instruction inserter 86 deploys, at a position user-specified using “!ocl contact(A(i,j),(−n),k)”, machine languages whose number is k and which correspond to a prefetch where the above-calculated prefetch address addr, calculated to precede by n elements, is specified, the k machine languages containing an instruction, “Iddf [% I1−256],f2”, “Iddf [% I1−128],f2” to serve as a subsequent cache line access, “Iddf [% I1],f2” to serve as a cache line access subsequent to “Iddf [% I1−128],f2”, . . . .

The computer executes programs for the compiler 1302 and the profiler 1303, and hence, the present embodiment may be realized. In addition, a computer-readable recording medium recording therein the above-mentioned program and a computer program product such as the above-mentioned program may be applied as embodiments of the present technology. As the recording medium, for example, a flexible disk, a hard disk, an optical disk, a magnet-optical disk, a CD-ROM, a magnetic tape, a non-volatile memory card, a ROM, or the like may be used.

In addition, the above-mentioned embodiments illustrate just examples of reduction to practice at the time of implementation of the present technology, and the technical scope of the present technology is not subjected to limited interpretation. In other words, the present technology may be implemented in various forms without departing from the technical idea thereof or the main features thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing device, comprising:
a cache memory configured to store data in a plurality of cache lines;
a hardware prefetch circuit configured to prefetch data to a cache line subsequent to a cache line in which cache misses occur when the cache misses occur in cache lines whose number is p at successive addresses in the cache memory; and
a controller configured to change values whose number is p in the hardware prefetch circuit when a number-of-cache-misses specifying instruction is input.

2. The arithmetic processing device according to claim 1, wherein
the hardware prefetch circuit prefetches data to a cache line subsequent to the cache-missed cache lines by q, and
the controller changes values whose number is q in the hardware prefetch circuit when a prefetch position specifying instruction is input.

3. The arithmetic processing device according to claim 1, wherein
the controller stops prefetch based on the hardware prefetch circuit when a prefetch stop instruction is input.

4. The arithmetic processing device according to claim 1, wherein
even when there are free cache lines whose number is r in the successive cache lines whose number is p, the hardware prefetch circuit determines that cache misses occur in the successive cache lines whose number is p, and
the controller changes values whose number is r in the hardware prefetch circuit when a number-of-free-cache-lines specifying instruction is input.

5. A control method for an arithmetic processing device including a cache memory configured to be able to store data in a plurality of cache lines, and a hardware prefetch circuit configured to prefetch data to a cache line subsequent to a cache line in which cache misses occur when the cache misses occur in cache lines whose number is p at successive addresses in the cache memory, the control method comprising:
causing data to be written into one cache line or the plural cache lines when a controller inputs an instruction for referencing a main memory.
